(19) United States
(12) Patent Application Publication
(10) Pub. No.: US 2016/0276088 A1
(43) Pub. Date: Sep. 22, 2016

(54) WIRE WOUND INDUCTOR AND METHOD OF MANUFACTURING THE SAME

(71) Applicant: SAMSUNG ELECTRO-MECHANICS CO., LTD., Suwon-si (KR)

(72) Inventors: Soon Kwang KWON, Suwon-si (KR); Jung Wook SEO, Suwon-si (KR); Hak Kwan KIM, Suwon-si (KR)

(21) Appl. No.: 15/060,229

(22) Filed: Mar. 3, 2016

(30) Foreign Application Priority Data
Mar. 18, 2015 (KR) 10-2015-0037407

(51) Int. Cl. H01F 27/255; H01F 41/10; H01F 41/02; H01F 27/28; H01F 27/29

(52) U.S. Cl. CPC H01F 27/255; H01F 27/2823; H01F 27/29; H01F 41/0246; H01F 41/10

(57) ABSTRACT

A wire wound inductor includes a winding coil, a magnetic core disposed in a central portion of the winding coil, and a body part filling a space around the winding coil and the magnetic core. The magnetic core has different characteristics from those of the body part, for example a higher permeability and higher magnetic flux density. In a method of manufacturing a wire wound inductor, a magnetic core is inserted in a central portion of a winding coil, wherein the magnetic core has different characteristics from those of a magnetic metal powder that is filled on the winding coil and the magnetic core. In one example, the filled magnetic metal powder is compressed at a pressure lower than a high pressure applied in the formation of the magnetic core.

### CROSS-REFERENCE TO RELATED APPLICATION

This application claims the priority and benefit of Korean Patent Application No. 10-2015-0037407, filed on Mar. 18, 2015 with the Korean Intellectual Property Office, the disclosure of which is incorporated herein by reference.

### BACKGROUND

The present disclosure relates to a wire wound inductor and a method of manufacturing the same.

As electronic products have been miniaturized and configured for multiple functions, miniaturization of inductor elements is increasingly required. In addition, as portable devices such as smartphones have been configured for multiple functions, inductor elements capable of sustaining higher currents are increasingly required.

Portable electronic devices obtain operating power having various voltage levels required in internal circuits using power supply circuits such as direct current (DC)-DC converters. Further, in inductors used in DC circuits, a high permeability material is generally needed to provide a high inductance while structurally suppressing magnetic saturation. To address this need, a material having high permeability and DC bias characteristics has been developed.

Inductors used in the technology as described above may be classified into various types, such as multilayer inductors, wire wound inductors, thin film inductors, and the like, depending on a structure thereof. There are differences in a method of manufacturing each of the inductors as well as an application range thereof.

Among such inductors, the wire wound inductor is formed by molding an internal wiring as a coil part using a mold. In some cases, a magnetic core using magnetic powder is provided, and permeability and magnetic flux density increase in proportion to a molding pressure. However, in the case of the wire wound inductor, there is a limitation in improving permeability and DC bias characteristics due to a low molding pressure.

### SUMMARY

An aspect of the present disclosure may provide a wire wound inductor and a method of manufacturing the same. More particularly, a wire wound inductor may have permeability and magnetic flux density that are increased by inserting a magnetic core in a central portion of a winding coil and by filling a space around the winding coil and the magnetic core with a body part.

According to an aspect of the present disclosure, a wire wound inductor may include the winding coil, the magnetic core disposed in the central portion of the winding coil, and the body part filling the space around the winding coil and the magnetic core. The magnetic core may have different characteristics from those of the body part.

The magnetic core may include magnetic metal powder or nano-crystalline powder molded at a high pressure, and the body part may include a magnetic metal powder that fills the space around the winding coil and the magnetic core. The magnetic metal powder may include at least one of Fe—Ni, amorphous Fe, Fe, and Fe—Cr—Si. The body part may include magnetic metal powders having different powder particle sizes.

The magnetic core may have a permeability and a magnetic flux density that are higher than those of the body part.

The winding coil may include a rectangular coil conductor wound in at least two layers.

The wire wound inductor may further include external electrodes electrically connected to lead terminals of the winding coil. Additionally, the lead terminals of the winding coil may face each other in parallel and may be spaced apart from each other.

According to another aspect of the present disclosure, a method of manufacturing a wire wound inductor may include filling a lower portion of a mold with magnetic metal powder. A winding coil is disposed on the filled magnetic metal powder. A magnetic core having different characteristics from those of the magnetic metal powder is formed, and the magnetic core is inserted into a central portion of the winding coil. The magnetic metal powder is filled on the winding coil and the magnetic core and the filled magnetic metal powder is cured.

Here, the method of manufacturing a wire wound inductor may further include providing the winding coil wound with at least one turn.

The method of manufacturing a wire wound inductor may further include forming external electrodes electrically connected to lead terminals of the winding coil.

According to exemplary embodiments, inductance and DC bias characteristics of the wire wound inductor may be improved by molding the magnetic metal powder or a nano-crystalline powder at a high pressure to form the magnetic core and inserting the magnetic core having different characteristics into the central portion of the winding coil.

The method may further include, prior to the curing, compressing the filled magnetic metal powder filled on the winding coil and the magnetic core at a pressure lower than the high pressure applied to form the magnetic core. For example, the forming of the magnetic core may include molding at a high pressure sufficient to provide the magnetic core with permeability and magnetic flux density higher than those of the filled magnetic metal powder. The forming of the magnetic core may further include performing heat treatment for removing stress caused by a molding pressure.

In accordance with a further aspect of the disclosure, a method of manufacturing a wire wound inductor includes forming a compressed powder magnetic core using a magnetic metal powder or a nano-crystalline powder by molding the magnetic metal powder or the nano-crystalline powder at a high pressure. The compressed powder magnetic core is disposed in a central portion of a winding coil. In turn, a body part containing the winding coil and the compressed powder magnetic core is formed by compressing a magnetic metal powder filled on the winding coil and on the compressed powder magnetic core at a pressure lower than the high pressure applied to form the compressed powder magnetic core.

The body part may be formed by compressing the magnetic metal powder at a pressure higher than 2 ton/cm².

The method may further include subjecting the compressed powder magnetic core to heat treatment after the step of molding at the high pressure and prior to the step of disposing the compressed powder magnetic core in the winding coil, in order to remove stress caused by the molding at the high pressure from the compressed powder magnetic core.

The forming of the body part containing the winding coil and the compressed powder magnetic core may further include curing the compressed magnetic metal powder after the compressing of the magnetic metal powder

The forming of the body part may include forming the body part using a magnetic material-resin composite in which magnetic metal powder and a resin mixture are mixed with each other, and the resin mixture may include at least one of epoxy, polyimide, and a liquid crystal polymer (LCP).

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view illustrating a schematic structure of a wire wound inductor according to an exemplary embodiment;

FIG. 2 is a schematic cross-sectional view taken along line I-I′ of FIG. 1;

FIG. 3 is a schematic cross-sectional view taken along line II-II′ of FIG. 1;

FIG. 4 is a view illustrating a winding coil according to the exemplary embodiment; and

FIG. 5 is a series of illustrations showing sequential steps of a method of manufacturing a wire wound inductor according to an exemplary embodiment.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concepts. In the drawings, for example, due to manufacturing techniques and/or tolerances, modifications of the shape shown may be estimated. Thus, embodiments of the present inventive concepts should not be construed as being limited to the particular shapes of regions shown herein, but should more generally be interpreted as including, for example, a change in shape resulting from a manufacturing process. The following embodiments may also be constituted by one or a combination thereof.

The contents of the present inventive concepts described below may have a variety of configurations, and only illustrative configurations are shown and described herein. The inventive concepts should not be interpreted as being limited to those illustrative configurations.

In wire wound inductors according to exemplary embodiments, inductance and DC bias characteristics of the wire wound inductors may be improved by molding magnetic metal powder at a high pressure to form a magnetic core and inserting the magnetic core into a central portion of the winding coil.

Here, the magnetic core may have different characteristics from those of the magnetic metal powder forming a body part.

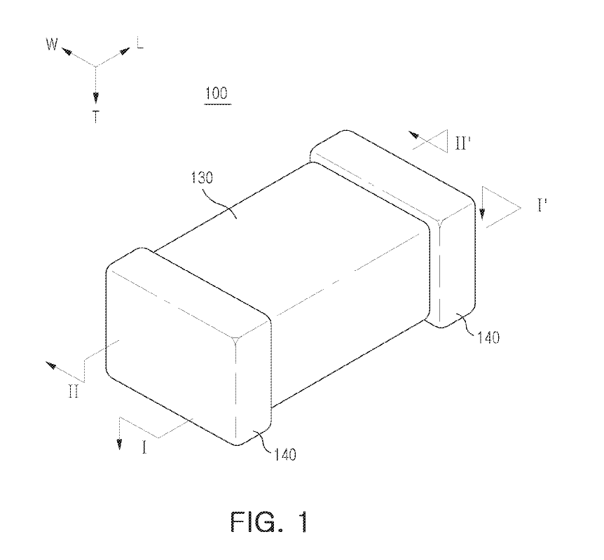

FIG. 1 is a perspective view illustrating a schematic structure of a wire wound inductor according to an exemplary embodiment.

Referring to FIG. 1, a wire wound inductor 100 including a winding coil may include a body part 130, external electrodes 140, and a winding coil (not illustrated). The body part 130, which forms an exterior of the wire wound inductor 100 while filling an internal portion of the wire wound inductor 100, may fill a space around the winding coil. The body part 130 as described above may be formed of magnetic metal powder.

Both end portions of the winding coil may be connected to the external electrodes 140, respectively. Although the external electrodes 140 are shown as being disposed on both ends of the wire wound inductor 100 in FIG. 1, a position of each of the external electrodes 140 may be variously determined depending on design and process requirements.

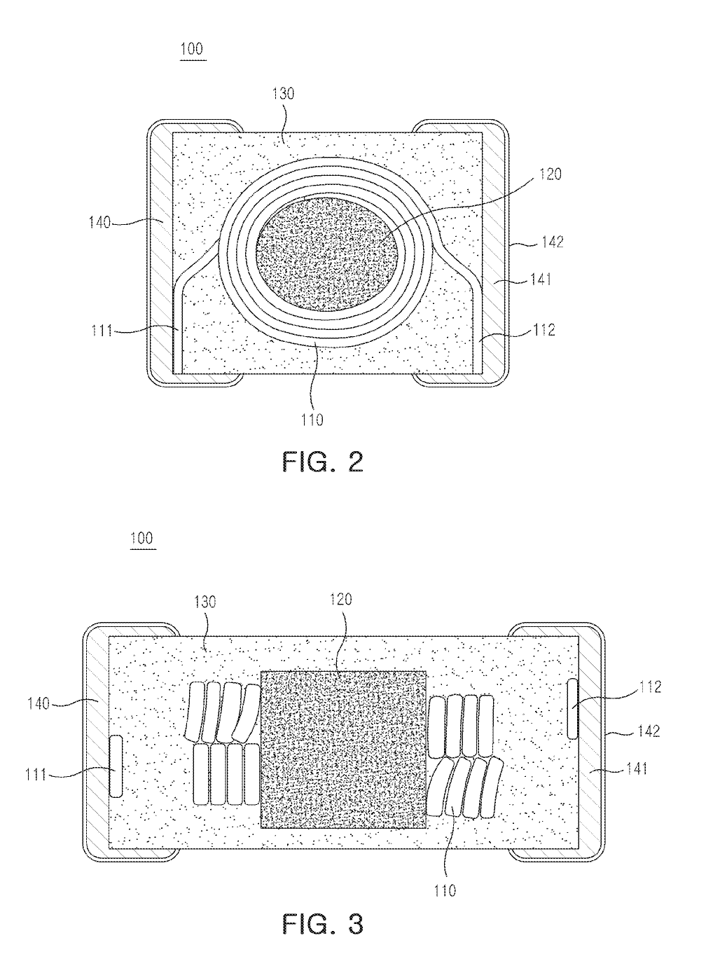

FIG. 2 is a schematic cross-sectional view taken along line I-I′ of FIG. 1, and FIG. 3 is a schematic cross-sectional view taken along line II-II′ of FIG. 1.

Referring to FIGS. 2 and 3, the wire wound inductor 100 according to the exemplary embodiment may include a winding coil 110, a magnetic core 120, and the body part 130.

The winding coil 110 may be an air-core coil, and a coil wound with at least one turn. Each end portion of the winding coil 110 may have a respective lead terminal 111 or 112. Further, each lead terminal of the pair of lead terminals 111 and 112 may be electrically connected to a respective external electrode of the pair of external electrodes 140.

For example, the winding coil 110 may be formed of a rectangular coil wound with at least one turn, and if necessary, the coil windings may be stacked in at least two layers. Further, in the winding coil 110, the pair of lead terminals 111 and 112 may face each other in parallel in a state in which they are spaced apart from each other, and the pair of lead terminals 111 and 112 may protrude forward of a winding portion of the winding coil 110 at a predetermined length.

The magnetic core 120 may be inserted into a central portion of the winding coil 110, such as a central portion of the coil that would otherwise provide an air-core. The magnetic core 120, which is formed by molding magnetic metal powder or nano-crystalline powder at a high pressure, may have different characteristics from those of the body part 130 that is not subjected to the high-pressure molding as described above.

For example, in a case of filling magnetic metal powder and applying a molding pressure of 1 to 2 ton/cm² or so to form the body part 130, the magnetic core 120 may be formed at a molding pressure higher than 1 to 2 ton/cm².

The magnetic core 120 may be molded at a high pressure to have permeability and magnetic flux density that are higher than those of the body party 130, and the magnetic core 120 may be subjected to heat treatment after the high-pressure molding is completed in order to remove stress caused by the molding pressure.

The magnetic core 120 inserted into the central portion of the winding coil 110 may suppress magnetic saturation generated in the winding coil 110 according to induction of a current in the winding coil 110. When the current is induced in the winding coil 110, a magnetic field is generated inside the coil, and a magnetic flux is amplified in a soft magnetic core by the magnetic field, thereby serving as an inductor. In this case, since the magnetic field is concentrated on the core inside the coil and thus magnetic saturation is generated inside the coil, in a case of inserting the magnetic core 120 having higher magnetic flux density into the central portion of the winding coil 110, high DC bias characteristics may be obtained by suppressing the magnetic saturation as described above.

The body part 130 may be formed of the magnetic metal powder. The magnetic metal powder may be filled on and below the winding coil 110 and the magnetic core 120 and then cured. In other words, the magnetic metal powder may be filled so that the winding coil 110 and the magnetic core 120 are embedded, and the body part 130 may be formed by curing the filled magnetic metal powder.

For example, the body part 130 may be formed of a magnetic material-resin composite in which magnetic metal powder and a resin mixture are mixed with each other. In this case, a filling rate may be further increased by applying pressure and/or by using magnetic metal powders having different sizes.

The magnetic metal powder may be formed of, for example, at least one of Fe—Ni, amorphous Fe, Fe, and Fe—Cr—Si. The resin mixture may be formed of, for example, at least one of epoxy, polyimide, and a liquid crystal polymer (LCP), although materials of the magnetic metal powder and the resin mixture are not limited thereto.

In addition, the wire wound inductor 100 according to the exemplary embodiment may further include the external electrodes 140, and the external electrodes 140 may be connected to the lead terminals 111 and 112 of the winding coil 110 exposed outwardly.

The winding coil 110 may have the pair of lead terminals 111 and 112, and the pair of external electrodes 140 corresponding thereto may be formed to thereby be electrically connected to the pair of lead terminals 111 and 112, respectively. Here, the external electrodes 140 may be formed on positions corresponding to both end portions of the body part 130.

The external electrodes 140 as described above may be formed by a method of dipping the body part of the inductor in a conductive paste, a printing method, a deposition method, a sputtering method, or the like.

The conductive paste 141 may contain a metal such as Ag, Ag—Pd, Ni, Cu, or the like, and if necessary, Ni plating layers and Sn plating layers may be formed on surfaces 142 of the external electrodes 140.

By molding the magnetic metal powder or the nano-crystalline powder having excellent magnetic characteristics at a high pressure, the magnetic core 120 having high magnetic flux density suppressing magnetic saturation in addition to high permeability may be obtained. Further, an inductor having high permeability may be obtained by inserting the magnetic core 120 as described above into the central portion of the winding coil 110.

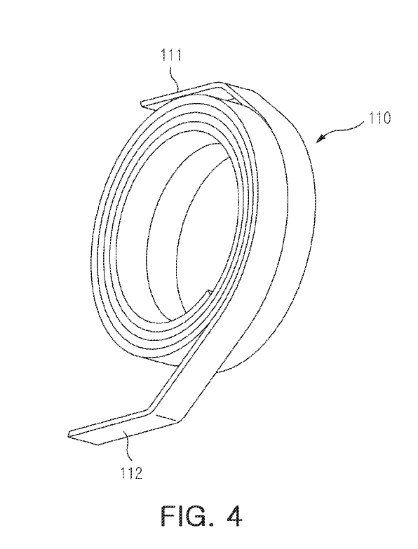

FIG. 4 is a view illustrating the winding coil according to the exemplary embodiment.

Referring to FIG. 4, the winding coil 110, which is a coil wound with at least one turn, may have the pair of lead terminals 111 and 112 at both end portions thereof.

The winding coil 110 may be wound with the air-core into which the magnetic core (e.g., 120) can be accommodated, and may be formed of the rectangular coil conductor as shown in FIGS. 3 and 4. Further, in the winding coil 110, the pair of lead terminals 111 and 112 may face each other in parallel and may be spaced apart from each other, and the pair of lead terminals 111 and 112 may protrude forward of the winding portion of the winding coil 110 at a predetermined length.

For example, the winding coil 110 may have a conductive via penetrating therethrough in a thickness direction, and may be formed of a metal wire disposed in a spiral shape and stacked in at least two layers as needed. Alternatively, the winding coil 110 may be formed by winding a metal wire in a bobbinless cylindrical shape so as to have a predetermined height. However, the winding coil 110 is not limited thereto.

For example, the winding coil 110 may have various shapes such as a circular shape, an oblong shape, an angular shape, and the like, and a material of the winding coil 110 may be copper (Cu), or the like.

Hereinafter, a method of manufacturing a wire wound inductor according to an exemplary embodiment will be described in detail by way of example.

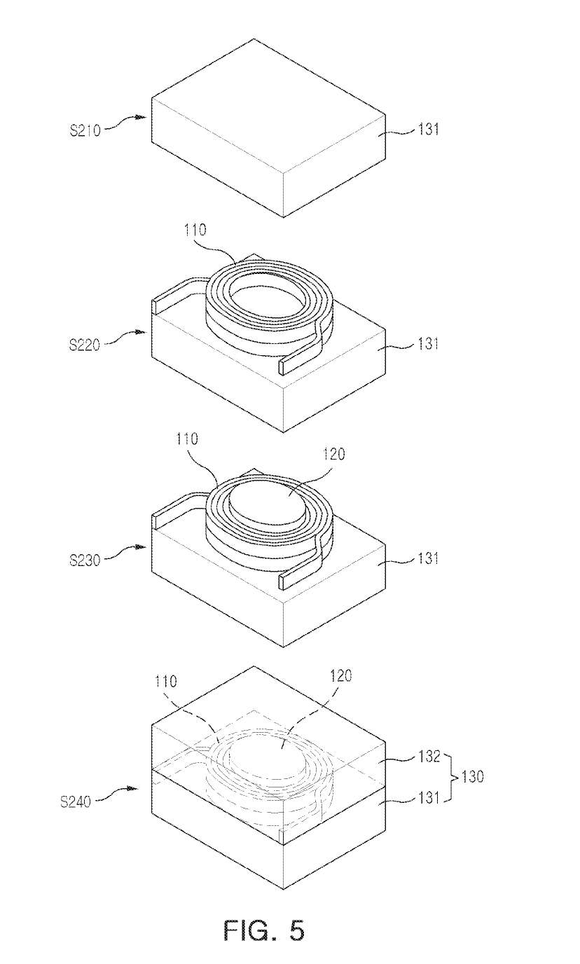

FIG. 5 is a series of illustrations showing sequential steps of a method of manufacturing a wire wound inductor according to an exemplary embodiment.

Referring to S210 of FIG. 5, magnetic metal powder may be filled in a lower portion of a mold, thereby forming a lower body part 131. Here, the lower body part 131 may constitute at least a portion of the body part 130.

The lower body part 131 may be formed, for example, by filling the magnetic metal powder in a fixed mold (not illustrated) disposed at both sides.

The lower body part 131 as described above may also be formed of a magnetic material-resin composite in which magnetic metal powder and a resin mixture are mixed with each other.

Referring to S220, a winding coil 110 may be disposed on the magnetic metal powder filled in the lower portion of the mold.

The winding coil 110 may be disposed at a central portion of the lower body part 131 including the magnetic metal powder. For example, lead terminals 111 and 112 formed at both end portions of the winding coil 110 may be adhered to or inserted into the fixed molds, and thus the winding coil may be disposed between a plurality of fixed molds.

Meanwhile, before the winding coil 110 is disposed on the lower body part 131 including the magnetic metal powder, a winding coil 110 wound with at least one turn may be prepared. The winding coil 110 may be an air-core coil, and both portions thereof may have a pair of lead terminals 111 and 112.

For example, in the winding coil 110, the pair of lead terminals 111 and 112 may face each other in parallel and be disposed such that they are spaced apart from each other, and the pair of lead terminals 111 and 112 may protrude forward of a winding portion of the winding coil 110 at a predetermined length.

Next, the magnetic core 120 may be formed by molding magnetic metal powder at a high pressure.

The magnetic core 120 may be formed by molding nano-crystalline powder as well as the magnetic metal powder at a high pressure, and may have different characteristics from those of the body part 130 that is not subjected to the high-pressure molding as described above.

For example, while the body part 130 can be formed by filling magnetic metal powder and applying a molding pressure of 1 to 2 ton/cm² or so, the magnetic core 120 may be formed at a molding pressure higher than 1 to 2 ton/cm².

The magnetic core 120 may also be formed of a magnetic material-resin composite in which magnetic metal powder and a resin mixture are mixed with each other. In this case, a filling rate may be further increased by applying pressure using magnetic metal powders having different sizes (e.g., magnetic metal powders having powder particles of different sizes).

The magnetic metal powder may be formed of, for example, at least one of Fe—Ni, amorphous Fe, Fe, and Fe—Cr—Si. The resin mixture may be formed of, for example, at least one of epoxy, polyimide, and a liquid crystal polymer (LCP), although materials of the magnetic metal powder and the resin mixture are not limited thereto.

The magnetic core 120 may be molded at a high pressure to have permeability and a magnetic flux density higher than those of the body party 130, and the magnetic core 120 may be subjected to heat treatment in order to remove stress caused by the molding pressure after the high-pressure molding.

Referring to S230, the molded magnetic core 120 may be inserted into the central portion of the winding coil 110.

The magnetic core 120 inserted into the central portion of the winding coil 110 may help to suppress magnetic saturation generated in the winding coil 110 according to induction of a current in the winding coil 110. When the current is induced in the winding coil 110, a magnetic field is generated from the inside of the coil, and a magnetic flux is amplified in a soft magnetic core by the magnetic field, thereby serving as an inductor. In this case, since the magnetic field is concentrated on the core inside the coil and thus magnetic saturation is generated inside the coil, in a case of inserting the magnetic core 120 having a higher magnetic flux density into the central portion of the winding coil 110, high DC bias characteristics may be obtained by suppressing the magnetic saturation as described above.

Referring to S240, the magnetic metal powder may be filled on the winding coil 110 and the magnetic core 120 and then cured.

An upper body part 132 may thereby be formed by inserting the magnetic metal powder through an opened upper surface of a molding space so as to embed the winding coil 110 and the magnetic core 120 and thereby fill the molding space. Here, the upper body part 132 may constitute at least a portion of the body part 130, and the body part 130 may include the upper body part 132 together with the lower body part 131.

As described above, the body part 130 including the lower and upper body parts 131 and 132 may be formed by filling a mold with the magnetic metal powder. Further, the body part 130 may be formed of the magnetic material-resin composite in which the magnetic metal powder and the resin mixture are mixed with each other in addition to the magnetic metal powder. In this case, the body part 130 may be completely filled by applying pressure using magnetic metal powders having different sizes, and thus a filling rate may be further increased.

The magnetic metal powder may be formed of, for example, at least one of Fe—Ni, amorphous Fe, Fe, and Fe—Cr—Si, and the resin mixture may be formed of, for example, at least one of epoxy, polyimide, and a liquid crystal polymer (LCP), but materials of the magnetic metal powder and the resin mixture are not limited thereto.

Thereafter, a wire wound inductor 100 may be completed by pressing a punch on opened upper and lower surfaces of the molding space to compress the magnetic metal powder filled on and below the winding coil 110, curing the compressed magnetic metal powder, and then separating the punch from the molding space of the fixed mold.

As described above, the wire wound inductor may be manufactured by filling the weighed magnetic metal powder in the lower portion of the mold, inserting the coil 110 manufactured in advance, inserting the magnetic core 120 into the coil, filling the magnetic metal powder again thereon, and applying a molding pressure of 1 to 2 ton/cm² or so to form a shape, followed by curing.

Here, in the magnetic core 120 using the magnetic metal powder to form a compressed powder magnetic core, permeability and magnetic flux density may be increased in proportion to the molding pressure. In a wire wound inductor, there is a limitation in improving permeability and DC bias characteristics due to low molding pressure, but a wire wound inductor having high permeability and high DC bias characteristics by suppressing magnetic saturation may be formed by molding a magnetic core to have a high magnetic core density and inserting the magnetic core in the winding coil 110 instead of the magnetic metal powder identical to that of the body part.

Meanwhile, a pair of external electrodes 140 electrically connected to the lead terminals 111 and 112 of the winding coil 110 may be formed. The external electrodes 140 may be connected to the lead terminals 111 and 112 of the winding coil 110 externally exposed and formed on positions corresponding to both end portions of the body part 130.

The external electrodes 140 as described above may be formed by a method of dipping the body part of the inductor in a conductive paste, a printing method, a deposition method, a sputtering method, or the like.

The conductive paste may contain a metal such as Ag, Ag—Pd, Ni, Cu, or the like, and if necessary, Ni plating layers and Sn plating layers may be formed on surfaces of the external electrodes 140.

As described above, the magnetic core 120 may be formed by performing heat treatment in order to remove stress caused by the molding pressure. The heat treatment can be performed after molding the magnetic metal powder or the nano-crystalline powder having excellent magnetic characteristics (such as permeability and magnetic flux density) at a high pressure to form a compressed powder magnetic core, or the like. The magnetic core 120 formed as described above may be inserted into the air-core coil 110. Therefore, the wire wound inductor 100 having high DC bias characteristics may be formed by inserting the magnetic core 120 molded at a high pressure into the central portion of the coil 110, instead of the magnetic metal powder forming the body part 130 filling the central portion of the coil 110.

When the magnetic powder or nano-crystalline powder having excellent magnetic characteristics is molded at a high pressure as in the compressed powder magnetic core, the magnetic core has high magnetic flux density and can suppress magnetic saturation in addition to exhibiting high permeability. In this situation, the inductor having high permeability may be manufactured by inserting the magnetic core in the central portion of the coil.

As described above, although the present disclosure has been described with reference to exemplary embodiments and the accompanying drawings, the present disclosure may be variously modified and changed by those skilled in the art. For example, even if the technologies described above are performed in a sequence different from that of the above-mentioned method, and/or components of a system, a structure, a device, a circuit, or the like, are coupled or combined in a form different from those in the above-mentioned method, or replaced or substituted with other components or equivalents, a suitable object may be achieved.

Therefore, other implementations, other exemplary embodiments, and equivalents are considered as being within the scope of the present disclosure.

While exemplary embodiments have been shown and described above, it will be apparent to those skilled in the art that modifications and variations could be made without departing from the scope of the present invention as defined by the appended claims.

What is claimed is:

1. A wire wound inductor comprising:
a winding coil;
a magnetic core disposed in a central portion of the winding coil; and
a body part filling a space around the winding coil and the magnetic core,
wherein the magnetic core has different characteristics from those of the body part.

2. The wire wound inductor of claim 1, wherein the magnetic core includes magnetic metal powder or nano-crystalline powder molded at a high pressure and is disposed in the central portion of the winding coil, and
the body part includes a magnetic metal powder that fills the space around the winding coil and the magnetic core.

3. The wire wound inductor of claim 2, wherein the magnetic metal powder includes at least one of Fe—Ni, amorphous Fe, Fe, and Fe—Cr—Si.

4. The wire wound inductor of claim 2, wherein the body part includes magnetic metal powders having different powder particle sizes.

5. The wire wound inductor of claim 2, wherein the magnetic core has a permeability and a magnetic flux density that are higher than those of the body part.

6. The wire wound inductor of claim 2, wherein the winding coil includes a rectangular coil conductor wound in at least two layers.

7. The wire wound inductor of claim 1, further comprising external electrodes electrically connected to lead terminals of the winding coil.

8. The wire wound inductor of claim 7, wherein the lead terminals of the winding coil face each other in parallel and are spaced apart from each other.

9. A method of manufacturing a wire wound inductor, the method comprising:
filling a lower portion of a mold with magnetic metal powder;
disposing a winding coil on the filled magnetic metal powder;
forming a magnetic core having different characteristics from those of the magnetic metal powder;
inserting the magnetic core into a central portion of the winding coil; and
filling the magnetic metal powder on the winding coil and the magnetic core and curing the filled magnetic metal powder.

10. The method of claim 9, further comprising providing the winding coil wound with at least one turn.

11. The method of claim 9, further comprising forming external electrodes electrically connected to lead terminals of the winding coil.

12. The method of claim 9, wherein the forming of the magnetic core includes molding magnetic metal powder or nano-crystalline powder at a high pressure to form the magnetic core.

13. The method of claim 12, further comprising:
compressing the filled magnetic metal powder filled on the winding coil and the magnetic core prior to the curing,
wherein the filled magnetic metal powder is compressed at a pressure lower than the high pressure applied to form the magnetic core.

14. The method of claim 12, wherein the forming of the magnetic core further includes performing heat treatment for removing stress caused by a molding pressure.

15. The method of claim 9, wherein the forming of the magnetic core includes molding at a high pressure sufficient to provide the magnetic core with permeability and magnetic flux density higher than those of the filled magnetic metal powder.

16. A method of manufacturing a wire wound inductor, the method comprising:
forming a compressed powder magnetic core using a magnetic metal powder or a nano-crystalline powder by molding the magnetic metal powder or the nano-crystalline powder at a high pressure;
disposing the compressed powder magnetic core in a central portion of a winding coil; and
forming a body part containing the winding coil and the compressed powder magnetic core by compressing a magnetic metal powder filled on the winding coil and on the compressed powder magnetic core at a pressure lower than the high pressure applied to form the compressed powder magnetic core.

17. The method of claim 16, wherein the body part is formed by compressing the magnetic metal powder at a pressure higher than 2 ton/cm².

18. The method of claim 16, further comprising:
subjecting the compressed powder magnetic core to heat treatment after the step of molding at the high pressure and prior to the step of disposing the compressed powder magnetic core in the winding coil, in order to remove stress caused by the molding at the high pressure from the compressed powder magnetic core.

19. The method of claim 16, wherein the forming the body part containing the winding coil and the compressed powder magnetic core further comprises curing the compressed magnetic metal powder after the compressing of the magnetic metal powder.

20. The method of claim 16, wherein:
the forming the body part comprising forming the body part using a magnetic material-resin composite in which magnetic metal powder and a resin mixture are mixed with each other, and
the resin mixture includes at least one of epoxy, polyimide, and a liquid crystal polymer (LCP).
